(19) United States
(12) Patent Application Publication
(10) Pub. No.: US 2016/0133122 A1
(43) Pub. Date: May 12, 2016

(54) SENSITIVITY ADJUSTMENT DEVICE, SENSITIVITY ADJUSTMENT METHOD, STORAGE MEDIUM, AND MONITORING SYSTEM

(71) Applicant: NEC CORPORATION, Tokyo (JP)

(72) Inventors: YOSHIO ISHIZAWA, Tokyo (JP); SATOSHI NAKAZAWA, Tokyo (JP)

(21) Appl. No.: 14/898,543

(22) PCT Filed: Jun. 9, 2014
(86) PCT No.: PCT/JP2014/003060

§ 371 Date: Dec. 15, 2015

(30) Foreign Application Priority Data
Jun. 25, 2013 (JP) 2013-132738

(51) Int. Cl. G08B 29/24

(52) U.S. Cl. CPC G08B 29/24

(57) ABSTRACT

In order to adjust the detection sensitivity in the detection of abnormal situations in response to conditions in a monitored location, this sensitivity adjustment device is equipped with an extraction unit and a sensitivity determination unit. With candidate location information (which indicates a candidate location, that is, a location which is close to a monitored location being monitored by the monitoring system, and is a location where an event affecting the degree of congestion of persons or vehicles may occur) used as a key, the extraction unit extracts information pertaining to an event scheduled for the candidate location from a database storing text written in regard to the event. In accordance with a predicted degree of congestion in the monitored location, which is predicted on the basis of the candidate location information and the information pertaining to the event extracted by the extraction unit, the sensitivity determination unit determines the detection sensitivity of the monitoring system in the detection of abnormal situations occurring in the monitored location.

### TECHNICAL FIELD

The present invention relates to a sensitivity adjustment device and the like that adjust a sensitivity to detect occurrence of an abnormal situation in a monitoring system.

### BACKGROUND ART

A monitoring system is a system for the purpose of improving a security in a station, an airport, and the like. The monitoring system includes a sensor, such as a monitoring camera and a sound collecting microphone. The monitoring system detects an abnormal situation using information outputted by the sensor and a monitoring rule.

The monitoring rule is a conditional expression including information defining a condition. The monitoring rule is, for example, the conditional expression “if (an image of a person putting down a bag is caught by a camera, and then, a person does not get close to the bag in a certain period of time) then (issue a warning)”. When a conditional clause (if clause) included in the foregoing monitoring rule is satisfied, the monitoring system issues a warning to a monitoring operator of the monitoring system. The monitoring operator who receives the issue knows that the abnormal situation “a bag is abandoned” has occurred.

NPL 1 discloses an example of a monitoring system for monitoring the state where a bag is abandoned in a public place.

### CITATION LIST

### Non Patent Literature

[NPL1] Detecting Abandoned Luggage Items in a Public Space Kevin Smith, Pedro Quelhas, and Daniel Gatica-Perez Proceedings of the 9th IEEE International Workshop on Performance Evaluation in Tracking and Surveillance (PETS '06), June 2006, pp.75-82

### SUMMARY OF INVENTION

### Technical Problem

In order for the monitoring system to effectively detect an abnormal situation, the monitoring system has to detect the abnormal situation at an appropriate sensitivity. The present inventors found that, in order for the monitoring system to effectively detect the abnormal situation, the sensitivity for detecting the abnormal situation must be adjusted in response to a condition in a monitored location.

It is a main object of the present invention to provide a sensitivity adjustment device, a sensitivity adjustment method, and a program that can appropriately adjust a sensitivity to detect an abnormal situation in response to a condition in a monitored location.

It is another object of the present invention to provide a monitoring system that can appropriately adjust a sensitivity to detect an abnormal situation in response to a condition in a monitored location.

### Solution to Problem

A sensitivity adjustment device of the present invention, as first aspect, includes
extraction unit that extracts, based on candidate location information representing a candidate location where close to a monitored location monitored by a monitoring system and where an event influencing a degree of congestion of a monitored target may occur, information regarding the event to occur in the candidate location, from a database in which a text representing the event is stored; and
sensitivity determination unit that determines a sensitivity when the monitoring system detects an abnormal situation that occurs in the monitored location in response to the degree of congestion in the monitored location, which is expected based on the candidate location information and the information regarding the event extracted by the extraction unit.

A sensitivity adjustment method of the present invention by a computer, as second aspect, includes
extracting, based on candidate location information representing a candidate location where close to a monitored location monitored by a monitoring system and where an event influencing a degree of congestion of a monitored target may occur, information regarding the event to occur in the candidate location, from a database in which a text representing the event is stored; and
determining a sensitivity when the monitoring system detects an abnormal situation that occurs in the monitored location in response to the degree of congestion in the monitored location, which is expected based on the candidate location information and the information regarding the extracted event.

A non-transitory computer-readable storage medium of the present invention storing a program which, as third aspect, makes a computer execute
processing of extracting, based on candidate location information representing a candidate location where close to a monitored location monitored by a monitoring system and where an event influencing a degree of congestion of a monitored target may occur, information regarding the event to occur in the candidate location, from a database in which a text representing the event is stored; and
processing of determining a sensitivity when the monitoring system detects an abnormal situation that occurs in the monitored location in response to the degree of congestion in the monitored location, which is expected based on the candidate location information and the information regarding the extracted event.

A monitoring system of the present invention, as fourth aspect, includes the monitoring server and the sensitivity adjustment device.

A sensitivity adjustment device of the present invention, as fifth aspect, includes
extraction unit that extracts, based on monitored location information representing a monitored location monitored by a monitoring system, information regarding an event to occur in the monitored location from a database in which a text representing the event is stored; and
sensitivity determination unit that determines a sensitivity when the monitoring system detects an abnormal situation that occurs in the monitored location in response to a degree of congestion in the monitored location, which is expected base on the monitored location information and the information regarding an event extracted by the extraction unit.

A sensitivity adjustment device of the present invention, as sixth aspect, includes congestion degree determination unit that receives, from a sensor that measures a condition in a monitored location monitored by a monitoring system, information representing the condition in the monitored location, and determining a degree of congestion of persons or vehicles in the monitored location based on the received information; and
sensitivity determination unit that determines a sensitivity when the monitoring system detects an abnormal situation that occurs in the monitored location in response to the degree of congestion in the monitored location determined by the congestion degree determination unit.

In addition, the objects of the present invention are achieved by a computer-readable storage medium storing the above-described program.

### Advantageous Effects of Invention

According to the present invention, a sensitivity adjustment device, a sensitivity adjustment method, and a program that can appropriately adjust a sensitivity to detect an abnormal situation in response to a condition in a monitored location can be provided.

In addition, according to the present invention, a monitoring system that can appropriately adjust a sensitivity to detect an abnormal situation in response to a condition in a monitored location can be provided.

### BRIEF DESCRIPTION OF DRAWINGS

FIG. 1 is a diagram illustrating an outline of a monitoring system 1000.

FIG. 2 is a block diagram illustrating a configuration of the monitoring system 1000 according to a first exemplary embodiment of the present invention.

FIG. 3 is a block diagram illustrating a configuration of a sensitivity adjustment device 300 according to the first exemplary embodiment of the present invention.

FIG. 4 is a block diagram illustrating a configuration of a monitoring system 2000 according to a second exemplary embodiment of the present invention.

FIG. 5 is a block diagram illustrating a configuration of a sensitivity adjustment device 400 according to the second exemplary embodiment of the present invention.

FIG. 6 is a diagram illustrating an example of information stored by a sensitivity table 450 according to the second exemplary embodiment of the present invention.

FIG. 7 is a diagram illustrating an example of information outputted by a sensitivity determination unit 440 according to the second exemplary embodiment of the present invention.

FIG. 8 is a flow chart illustrating an operation of the sensitivity adjustment device 400 according to the second exemplary embodiment of the present invention.

FIG. 9 is a diagram illustrating an example of the information stored by the sensitivity table 450 according to the second exemplary embodiment of the present invention.

FIG. 10 is a diagram illustrating an example of information stored by an event type dictionary 470 according to the second exemplary embodiment of the present invention.

FIG. 11 is a diagram illustrating an example of the information stored by the sensitivity table 450 according to the second exemplary embodiment of the present invention.

FIG. 12 is a block diagram illustrating a configuration of a sensitivity adjustment device 500 according to a third exemplary embodiment of the present invention.

FIG. 13 is a block diagram illustrating a configuration of a sensitivity adjustment device 600 according to a fourth exemplary embodiment of the present invention.

FIG. 14 is a block diagram illustrating an example of a hardware configuration of an information processing device 3000, which can achieve a sensitivity adjustment device of the present invention.

### DESCRIPTION OF EMBODIMENTS

Initially, for the purpose of easy understanding of the invention, details of a monitoring system 1000 to which the present invention can be applied and details of problems to be solved by the invention will be described respectively.

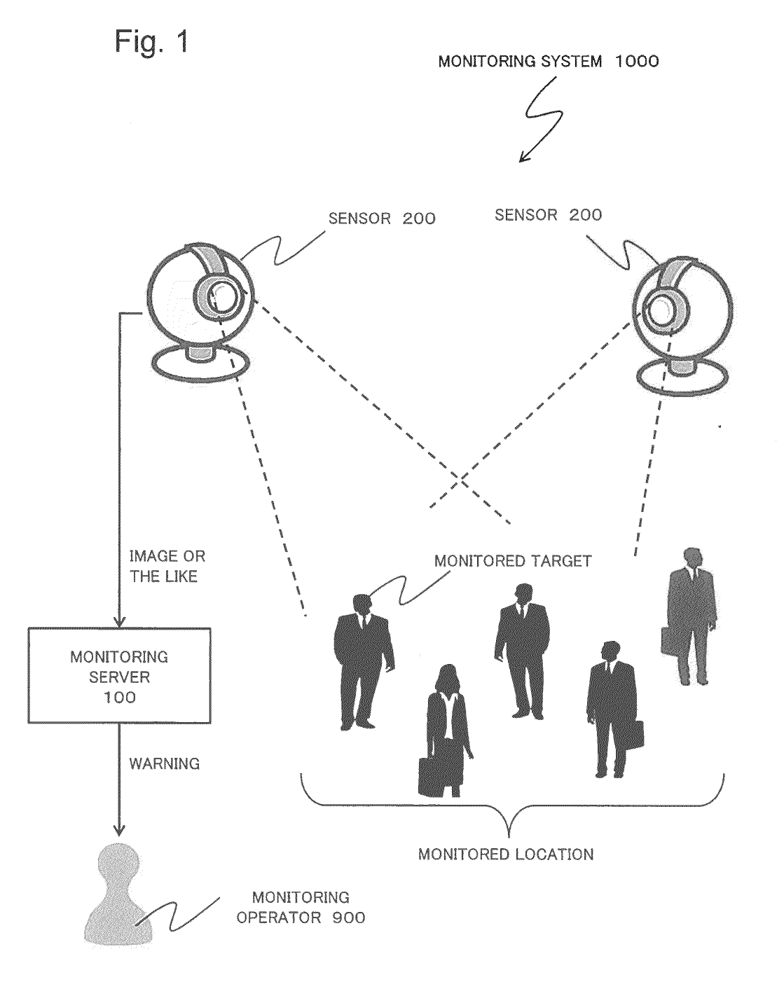

Firstly, the details of the monitoring system 1000 to which the present invention can be applied will be described. FIG. 1 is a diagram for illustrating an outline of the monitoring system 1000. The monitoring system 1000 includes a monitoring server 100 and one or more sensors 200.

The sensor 200 measures a condition in a monitored location that is a location monitored by the monitoring system. The sensor 200 is, for example, a monitoring camera and a sound collecting microphone. Hereinafter, for the purpose of easy understanding of the invention, the description will be continued on the assumption that the sensor 200 is a monitoring camera. The monitoring camera shoots the monitored location. The monitored location is, for example, a range caught by one monitoring camera. The monitored location may be a range monitored by multiple monitoring cameras. The monitored location may be, for example, a specific store, a specific park, a specific area fixed by latitude and longitude, and the like.

By monitoring a behavior of a monitored target in the monitored location, the monitoring system 1000 detects an abnormal situation. The monitored target is, for example, a person, a vehicle, a bicycle, an object (such as a bag), and an animal existing in the monitored location. Hereinafter, for the purpose of easy understanding of the invention, the description will be continued on the assumption that the monitored target is a person.

The sensor 200 (monitoring camera) transmits information obtained by measuring the condition in the monitored location (image or the like) to the monitoring server 100.

The monitoring server 100 receives the information obtained by measuring the condition in the monitored location from the sensor 200. The monitoring server 100 detects whether an abnormal situation has occurred in the monitored location. In the monitoring server 100, a monitoring rule to detect an abnormal situation is set.

The monitoring rule is a conditional expression including information defining a specific condition. The monitoring rule is, for example, the conditional expression “if (an image of a person putting down a bag is caught by a camera, and then, a person does not get close to the bag in a certain period of time) then (issue a warning to a monitoring operator 900)”.

When receiving the information obtained by measuring the condition in the monitored location from the sensor 200 (monitoring camera), the monitoring server 100 analyzes the received information and extracts a behavior, an attribution, or the like of the monitored target (a person or the like) in the monitored location. The monitoring server extracts a behavior of the monitored target (for example, walking, talking, or the like) using a behavior estimation technique, for example. The monitoring server extracts an attribution of the monitored target (for example, age, gender, or the like) using a facial recognition technique, for example. When the behavior or the attribution of the monitored target extracted by the monitoring server 100 satisfies a conditional clause (if clause) included in the monitoring rule, the monitoring server 100 executes a then clause included in the monitoring rule.

Hereinafter, a conditional clause included in a monitoring rule will be referred to as “a conditional clause of a monitoring rule”. Hereinafter, a then clause included in a monitoring rule will be referred to as “a then clause of a monitoring rule”.

A sensitivity of the monitoring system 1000 to detect an abnormal situation depends on a variable included in the conditional clause of the monitoring rule, for example. A concrete description will be made by taking the above-described monitoring rule as an example.

For example, the following Monitoring Rule 1 and Monitoring Rule 2 will be considered.

Monitoring Rule 1: the monitoring rule including the conditional clause “if (an image of a person putting down a bag is caught by a camera, and then, a person does not get close to the luggage (bag) during the next thirty minutes)”, and

Monitoring Rule 2: the monitoring rule including the conditional clause “if (an image of a person putting down a bag is caught by a camera, and then, a person does not get close to the luggage (bag) during the next one hour)”.

It can be said that the monitoring system 1000 in which Monitoring Rule 1 is set has a higher sensitivity to detect the abnormal situation “the bag is abandoned” than the monitoring system 1000 in which Monitoring Rule 2 is set.

When the sensitivity to detect the abnormal situation is high, a detection leakage with respect to the abnormal situation decreases, but a false detection of the abnormal situation increases. When the sensitivity to detect the abnormal situation is low, there is a little false detection of the abnormal situation, but there is much detection leakage with respect to the abnormal situation.

In order for the monitoring system 1000 to effectively detect an abnormal situation, the monitoring system 1000 has to detect occurrence of the abnormal situation at an appropriate sensitivity.

Next, the problems to be solved by the present invention will be described in detail.

The present inventors found that, in order for the monitoring system 1000 to effectively detect an abnormal situation, the sensitivity to detect the abnormal situation must be adjusted in response to a degree of congestion of the monitored target in the monitored location.

The degree of congestion of the monitored target will be described. For example, when the monitored target is a person, the degree of congestion is the number of persons per unit area. The condition where the degree of congestion is high represents the condition where there are many persons in the monitored location, for example.

For example, when the monitored target is a vehicle, the degree of congestion is the number of vehicles per unit area or per unit length. The condition where the degree of congestion is high represents the condition where many vehicles are parked in a parking area or the condition where there is a traffic jam of vehicles, for example.

The reason why the sensitivity to detect the abnormal situation must be adjusted in response to the degree of congestion of the monitored target in the monitored location will be described. The reason is mainly composed of the following two reasons.

The first reason is a reason derived from characteristics of an abnormal situation that is wanted to be detected.

For example, the case where the monitoring system 1000 detects the criminal behavior “stalking behavior” will be considered. The following example is a monitoring rule for detecting a stalking behavior.

Monitoring Rule: “if (there is a person who follows a specific person for more than five minutes while keeping a distance within a constant distance (X meters) with the specific person) then (save the moving image to a database, and set a flag representing a stalking behavior to the moving image)”.

When the degree of congestion in the monitored location is low, it is appropriate that a variable (X meters) included in the conditional clause of Monitoring Rule is set to be a high sensitivity (i.e. long distance). This is because, when the degree of congestion in the monitored location is low, a criminal who performs a stalking behavior can follow a victim without losing the victim even when being separated by a certain distance from the victim.

When the degree of congestion in the monitored location is high, it is appropriate that the variable (X meters) included in the conditional clause of Monitoring Rule is set to be a low sensitivity (i.e. short distance). This is because, when the degree of congestion in the monitored location is high, a common person who is not associated with the stalking behavior walks while keeping a short distance with a person who walks ahead. In this case, if a relatively-short distance is set as the variable X, false detection of the stalking behavior may be increased.

In this manner, because of the reason derived from characteristics of an abnormal situation that is wanted to be detected, the sensitivity to detect the abnormal situation must be adjusted in response to the degree of congestion of the monitored target in the monitored location.

The second reason is a reason derived from monitoring cost of the monitoring operator 900 who receives a warning from the monitoring server 100. For example, the case where the monitoring system 1000 detects whether a wanted person is caught by an image shot by a monitoring camera will be considered. The following example is a monitoring rule for detecting a wanted person.

Monitoring Rule: “if (a face of a person caught by an image corresponds to a face of a wanted person at a degree of reliability of a predetermined value (Y %) or more) then (issue a warning to the monitoring operator 900)”.

Here, when the degree of congestion in the monitored location is low, it is appropriate that a variable (Y %) included in the conditional clause of Monitoring Rule is set to be a high sensitivity (i.e. low value). This is because, when the variable (Y %) is set to be a higher sensitivity, a risk of detection leakage of the wanted person is decreased.

Here, when the degree of congestion in the monitored location is high, it is appropriate that the variable (Y %) included in the conditional clause of Monitoring Rule is set to be a low sensitivity (i.e. high value). This is because, when the degree of congestion in the monitored location is high, faces of many persons are caught by the image of the monitoring camera, and thus, the number of times that warnings are issued to the monitoring operator 900 is increased. The number of cases that the monitoring operator 900 can confirm warnings in real time is finite. In this case, it is appropriate that the variable (Y %) included in the conditional clause of Monitoring Rule is set to be a high sensitivity so as not to give notice of a warning having a high risk of false detection.

In this manner, because of the reason derived from monitoring cost of the monitoring operator 900, the sensitivity to detect the abnormal situation must be adjusted in response to the degree of congestion of the monitored target in the monitored location.

In the above-described example, congestion of the monitored target causes a situation in that only a half of a face of a person is captured in the image of the monitoring camera, or the like, and the situation is increased. In this situation, the degree of reliability of facial recognition is decreased. From this viewpoint, when the degree of congestion in the monitored location is high, it is appropriate that the variable (Y %) included in the conditional clause of Monitoring Rule is set to be a low sensitivity.

Hereinafter, exemplary embodiments of the present invention which can solve the foregoing problems will be described in detail with reference to drawings.

### First Exemplary Embodiment

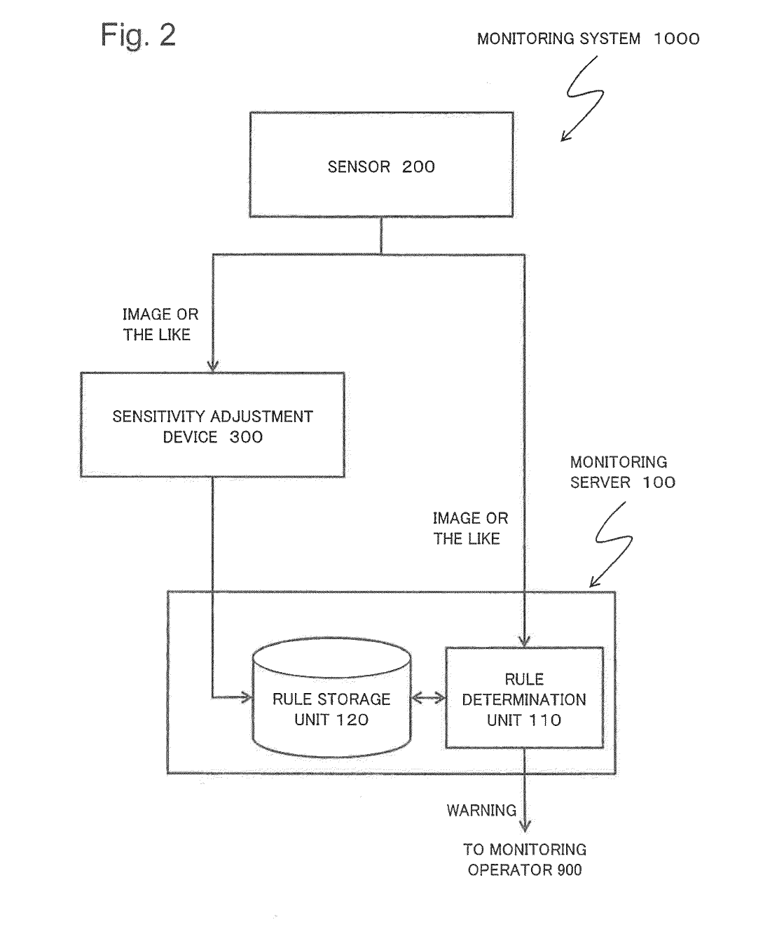

FIG. 2 is a block diagram illustrating a configuration of a monitoring system 1000 according to a first exemplary embodiment. As illustrated in FIG. 2, the monitoring system 1000 includes a sensor 200, a monitoring server 100, and a sensitivity adjustment device 300. The monitoring server 100 and the sensitivity adjustment device 300 may be the same device.

As illustrated in FIG. 2, the monitoring server 100 includes a rule determination unit 110 and a rule storage unit 120.

The rule determination unit 110 receives information obtained by measuring a condition in the monitored location from the sensor 200. The rule determination unit 110 analyzes the received information and extracts a behavior, an attribution, or the like of a monitored target in the monitored location. The rule determination unit 110 refers to the rule storage unit 120 and searches a monitoring rule including the conditional clause (if clause) that matches the behavior, the attribution, or the like of the monitored target. When the monitoring rule is searched, the rule determination unit 110 executes an operation defined by the then clause included in the monitoring rule.

The rule storage unit 120 stores the monitoring rule. The monitoring rule is stored while being associated with the monitored location, for example. The monitoring rule is stored while being associated with a monitored period, for example.

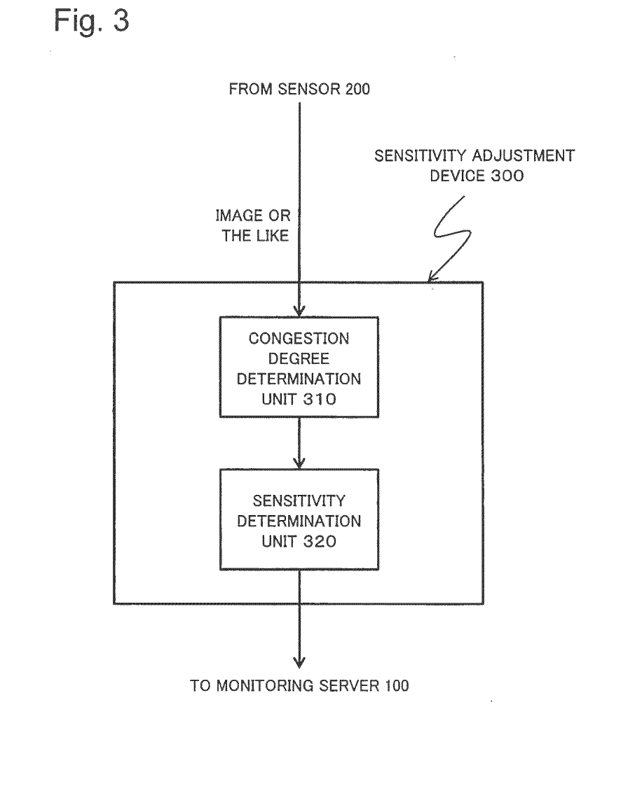

FIG. 3 is a block diagram illustrating a configuration of the sensitivity adjustment device 300 illustrated in FIG. 2. As illustrated in FIG. 3, the sensitivity adjustment device 300 includes a congestion degree determination unit 310 and a sensitivity determination unit 320.

The congestion degree determination unit 310 receives information representing the condition in the monitored location from the sensor 200. The congestion degree determination unit 310 determines the degree of congestion of the monitored target in the monitored location based on the received information. The congestion degree determination unit 310 determines the degree of congestion of the monitored target in the monitored location using a facial recognition technique or a voice recognition technique, for example.

The sensitivity determination unit 320 determines the sensitivity when the monitoring system 1000 detects the abnormal situation that occurs in the monitored location based on the degree of congestion determined by the congestion degree determination unit 310.

The sensitivity determination unit 320 may determine the sensitivity by referring to a table or the like that stores information in which the degree of congestion is associated with the sensitivity.

The sensitivity determination unit 320 may update the monitoring rule stored in the rule storage unit 120 based on the determined sensitivity.

The sensitivity determination unit 320 may transmit the determined sensitivity to the monitoring server 100. In this case, the monitoring server 100 may include a monitoring rule update unit not illustrated in the drawing, which updates the monitoring rule stored in the rule storage unit 120, based on the received sensitivity.

Effects achieved by the sensitivity adjustment device 300 according to the first exemplary embodiment will be described.

According to the sensitivity adjustment device 300 of the first exemplary embodiment, the sensitivity to detect occurrence of the abnormal situation can be appropriately adjusted in response to the condition in the monitored location.

For example, the case where the monitoring system 1000 monitors a movement of a crowd at a station ticket gate will be considered. When a train arrives and many persons get off the train, an image of a large number of persons moving in the same direction in a short period of time is caught by a monitoring camera. Thus, compared with normal time other than immediately after arrival of a train, there is a risk that, in the monitoring system 1000, the monitoring server 100 falsely detects a common condition where a crowd gets off a train and passes through the ticket gate as the abnormal situation “a crowd evacuates”. In order to prevent this false detection, the sensitivity to detect the abnormal situation has to be adjusted on arrival of a train. According to the sensitivity adjustment device 300 of the first exemplary embodiment, in this case, the sensitivity (variable) included in the monitoring rule (the sensitivity of the monitoring rule) can be appropriately adjusted.

For example, the case where the monitoring system 1000 detects whether a crowd disturbance occurs at a station ticket gate will be considered. In this case, for example, when an event such as a half-price sale occurs at a store near the station, it is expected that many persons gather in the station. Thus, there is a risk that the monitoring system 1000 falsely detects a common condition where a crowd heads to the store in which the half-price sale is held using a train as the abnormal situation “a crowd evacuates”. In order to prevent this false detection, the sensitivity to detect the abnormal situation has to be adjusted at the time of congestion. According to the sensitivity adjustment device 300 of the first exemplary embodiment, in this case, the sensitivity (variable) included in the monitoring rule (the sensitivity of the monitoring rule) can be appropriately adjusted.

### Second Exemplary Embodiment

Firstly, an outline of a sensitivity adjustment device 400 according to a second exemplary embodiment will be described. Depending on the performance of the monitoring server 100 or the content of information received from the sensor 200, it is sometimes difficult for the monitoring server 100 to determine the degree of congestion in the monitored location in real time. For example, when the performance of the monitoring server 100 is low, it is difficult to perform image processing of the image received from the sensor 200 in real time and determine the degree of congestion in the monitored location in real time. For example, when the performance of the sensor 200 that is a monitoring camera is low, it is difficult to perform facial recognition processing or the like to the low-quality image shot by the sensor 200 in real time and determine the degree of congestion in the monitored location in real time.

In particular, when the degree of congestion in the monitored location is high, it is considered that, in many cases, overlapped bodies of persons are caught by an image shot by the sensor. Processing for determining the degree of congestion based on the foregoing image is generally processing that requires an advanced information processing capacity.

The sensitivity adjustment device 400 according to the second exemplary embodiment can solve the foregoing problem. The sensitivity adjustment device 400 according to the second exemplary embodiment perceives an event to occur in a location close to the monitored location in advance. Accordingly, the sensitivity adjustment device 400 according to the second exemplary embodiment can predict the degree of congestion in the monitored location before monitoring is executed. The sensitivity adjustment device 400 according to the second exemplary embodiment determines the sensitivity when the monitoring system 1000 detects the abnormal situation, based on the degree of congestion in the monitored location predicted by the event to occur in the location close to the monitored location.

The sensitivity adjustment device 400 according to the second exemplary embodiment will be described in detail with reference to drawings.

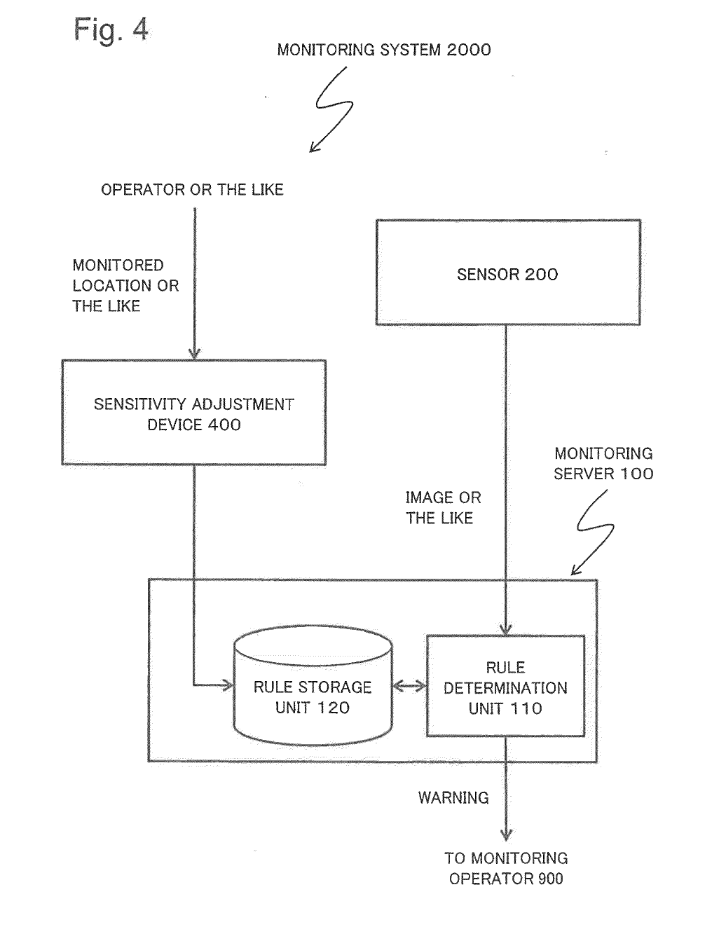

FIG. 4 is a block diagram illustrating a configuration of a monitoring system 2000 including the sensitivity adjustment device 400 according to the second exemplary embodiment. As illustrated in FIG. 4, the monitoring system 2000 includes the monitoring server 100, the sensor 200, and the sensitivity adjustment device 400. Since a configuration that is substantially the same as the configuration illustrated in FIG. 2 is denoted by the same reference numeral, the description is omitted.

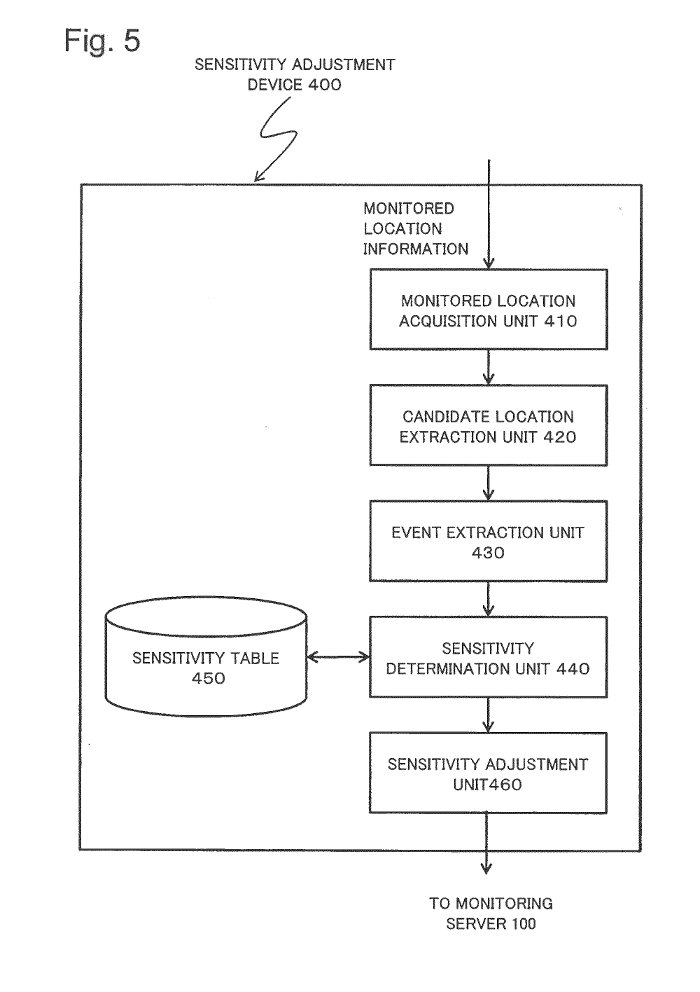

FIG. 5 is a block diagram illustrating a configuration of the sensitivity adjustment device 400 illustrated in FIG. 4. As illustrated in FIG. 5, the sensitivity adjustment device 400 includes a monitored location acquisition unit 410, a candidate location extraction unit 420, an event extraction unit 430, a sensitivity determination unit 440, a sensitivity table 450, and a sensitivity adjustment unit 460.

The monitored location acquisition unit 410 acquires monitored location information representing the monitored location.

The monitored location may be, for example, an identifier of the monitoring camera. In this case, the sensitivity adjustment device 400 may store a correspondence relationship between the identifier of the monitoring camera and an installation location of the monitoring camera. The monitored location may be, for example, a specific store, a specific park, a specific station, a specific area fixed by latitude and longitude, and the like.

The candidate location extraction unit 420 extracts a “candidate location” that is a location close to the monitored location represented by the monitored location information acquired by the monitored location acquisition unit 410, and a location where an event influencing the degree of congestion of persons or vehicles may occur.

Here, the “event” represents an event in which an increase or decrease of the monitored target (persons or the like) in the monitored location is expected. For example, when a “sale” that is an example of the event occurs, it is expected that many persons come to a store where the sale occurs during the sale. For example, when “road repairing” that is an example of the event starts, persons move while avoiding a location where the road repairing is carried out, and thus, it is expected that the number of persons is decreased at the periphery of the location where the road repairing is carried out.

The candidate location extraction unit 420 is achieved by using a database in which a location that can be a candidate of a location where an event is held, i.e. an event site, a store, a park, a road, a landform, or the like is stored with its positional information. An example of the foregoing database is indicated below [Reference 1].

### [Reference 1]

Google Maps [https://maps.google.co.jp/ (Google is a registered trademark.)]

The candidate location extraction unit 420 extracts, for example, a candidate location close to the monitored location “A intersection” as follows. For example, the case where a store and the like exist close to “A intersection” that is the monitored location at the following distances will be considered.
Department store A: The distance from A intersection is 150 meters,
Bank B: The distance from A intersection is 100 meters,
Gas station C: The distance from A intersection is 400 meters, and
Clothing store D: The distance from A intersection is 350 meters.

A threshold value of the distance between the monitored location and the candidate location is assumed to be 300 meters, for example. In this case, the candidate location extraction unit 420 extracts Department store A, Bank B, and Clothing store D as the candidate locations, using the database represented by [Reference 1], for example.

The monitored location information or candidate location information may include, for example, positional information, such as a name of the location (for example, store's name), an address of the location, and latitude and longitude of the location.

The event extraction unit 430 receives input of the candidate location information extracted by the candidate location extraction unit 420. The event extraction unit 430 extracts “information regarding the event” to occur in the candidate location from the database in which a text representing the event is stored, using the candidate location information as a key.

The event extraction unit 430 accesses the Internet, for example, and searches text information describing the event from a database existing on the Internet. The event extraction unit 430 extracts the “information regarding the event” to occur in the candidate location from the searched text information. The information regarding the event is, for example, the presence or absence of the holding of the event, the type of the event to occur, information representing the holding period of the event, or the like.

For example, regarding Department store A, the event extraction unit 430 extracts scheduling of the event “half-price sale” in the holding period “July to August”. For example, regarding Bank B, the event extraction unit 430 extracts the absence of an event to occur in particular. For example, regarding Clothing store D, the event extraction unit 430 extracts scheduling of the event “bargain sale on summer clothes” in the holding period “August to September”.

How the event extraction unit 430 extracts the event will be described concretely. The event extraction unit 430 may store a keyword regarding the event, for example. The keyword regarding the event is, for example, a noun representing a name of the event (for example, “sale”, “road repairing”, or the like) or a verb representing occurrence of the event (for example, “occur”, “is held”, “is opened” or the like).

The event extraction unit 430 searches, for example, a text document including both the keyword regarding the event and the candidate location information and performs extraction processing using a known text mining technique.

The event extraction unit 430 is achieved by applying a technique disclosed in [Reference 2], for example.

### [Reference 2]

Japanese Unexamined Patent Application Publication No. 2004-102559

The sensitivity determination unit 440 determines the sensitivity when the monitoring system 2000 detects the abnormal situation that occurs in the monitored location in response to the degree of congestion in the monitored location which is expected based on the monitored location information, the candidate location information, the information regarding the event, and the like. Specifically, the sensitivity determination unit 440 determines a sensitivity adjustment parameter.

Here, the sensitivity adjustment parameter will be described. The sensitivity adjustment parameter is a parameter for adjusting a value of a variable included in the conditional clause of the monitoring rule. For example, the following Monitoring Rule will be assumed.

Monitoring Rule: “if (a face of a person caught by an image corresponds to a face of a wanted person at a degree of reliability of 90% or more) then (issue a warning to the monitoring operator 900)”.

The sensitivity of the monitoring rule is adjusted by calculating the value of the variable included in the monitoring rule and the value of the sensitivity adjustment parameter. For example, the case where the above-described Monitoring Rule is adjusted by the sensitivity adjustment parameter having a value of “1.1” will be considered. Then, the value of the variable included in the conditional clause of the monitoring rule is adjusted to be 90(%)×1.1=99(%), for example. Here, “×” is a sign indicating multiplication.

The calculation performed between the value of the variable included in the monitoring rule and the value of the sensitivity adjustment parameter is naturally not limited to multiplication and may be other calculations.

Hereinafter, for the purpose of easy understanding of the description, the description will be continued on the assumption that, as the value of the sensitivity adjustment parameter becomes larger, the sensitivity of the monitoring rule is decreased when the value of the sensitivity adjustment parameter is calculated with the value of the variable. The relationship between the size of the value of the sensitivity adjustment parameter and the sensitivity of the monitoring rule is not limited to the above-described relationship.

Examples of a method for the sensitivity determination unit 440 to determine the sensitivity adjustment parameter include various variations. Hereinafter, one variation among the various variations will be described.

Based on the positional information included in the monitored location, positional information included in the candidate location information, and the information regarding the event extracted by the event extraction unit 430, the sensitivity determination unit 440 determines the sensitivity adjustment parameter by referring to the sensitivity table 450.

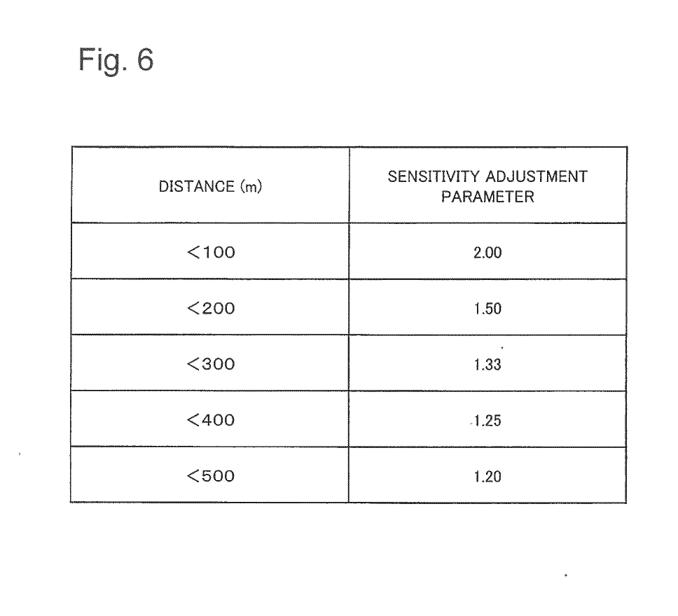

FIG. 6 is information illustrating an example of information stored by the sensitivity table 450. The sensitivity table 450 illustrated in FIG. 6 stores information in which the distance from the monitored location to the candidate location is associated with the value of the sensitivity adjustment parameter. As illustrated in FIG. 6, in the sensitivity table 450, the sensitivity adjustment parameter in which the influence on the sensitivity of the monitoring rule is increased (the sensitivity is greatly decreased) as the distance from the monitored location to the candidate location is shortened is set. This is because it is considered that the degree of congestion in the monitored location is influenced more strongly by the degree of congestion in the event site as the distance from the monitored location to the event cite is shortened.

The distance from the monitored location to the candidate location is calculated based on the positional information of the monitored location and the positional information of the candidate location. The distance may be a straight-line distance or a pathway distance along a road between the monitored location and the candidate location. The distance may be a weighted distance in consideration of a good landscape, ease of walking, and the like from the monitored location to the candidate location.

For example, regarding Department store A, the distance from the monitored location is 150 meters, and thus, the sensitivity determination unit 440 acquires the sensitivity adjustment parameter of 1.5. For example, regarding Clothing store D, the distance from the monitored location is 350 meters, and thus, the sensitivity determination unit 440 acquires the sensitivity adjustment parameter of 1.25. Here, the holding period of the “half-price sale” that occurs in Department store A is July to August, and the holding period of the “bargain sale on summer clothes” that occurs in Clothing store D is August to September. Accordingly, only Department store A has to be considered regarding the sensitivity adjustment parameter of July, and thus, the sensitivity determination unit 440 determines that the sensitivity adjustment parameter is 1.5.

Only Clothing store D has to be considered regarding the sensitivity adjustment parameter of September, and thus, the sensitivity determination unit 440 determines that the sensitivity adjustment parameter is 1.25. The sensitivity determination unit 440 has to consider both Department store A and Clothing store D regarding the sensitivity adjustment parameter of August. For example, the sensitivity determination unit 440 may set the maximum value of the sensitivity adjustment parameter determined based on the Department store A and Clothing store D, as the sensitivity adjustment parameter of August. The sensitivity determination unit 440 may set another statistical value, such as a sum value or an average value, as the sensitivity adjustment parameter, without limiting to the maximum value.

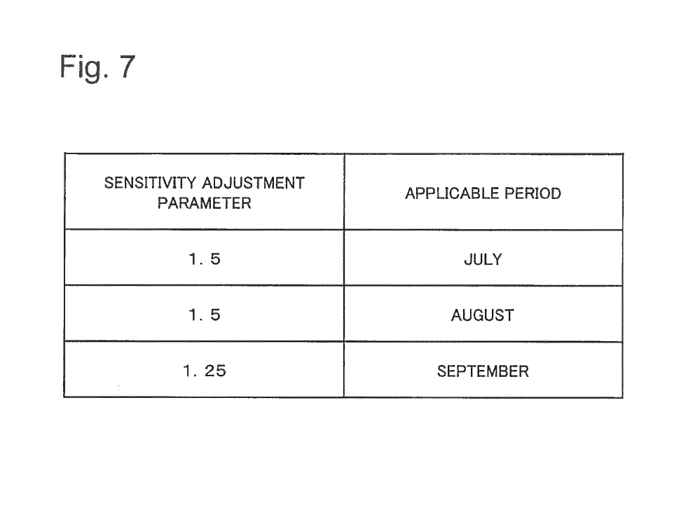

The sensitivity determination unit 440 associates the sensitivity adjustment parameter with a valid period of the sensitivity adjustment parameter, and outputs them, for example. FIG. 7 is a diagram illustrating an example of information outputted by the sensitivity determination unit 440.

As illustrated in FIG. 7, the sensitivity determination unit 440 outputs 1.5 as the sensitivity adjustment parameter of July, 1.5 as the sensitivity adjustment parameter of August, and 1.25 as the sensitivity adjustment parameter of September.

Returning to the description referring to FIG. 5, the sensitivity adjustment unit 460 updates the rule stored in the rule storage unit 120 included in the monitoring server 100 based on the sensitivity adjustment parameter determined by the sensitivity determination unit 440. The sensitivity adjustment unit 460 may be included not as a function of the sensitivity adjustment device 400 but as a function of the monitoring server 100.

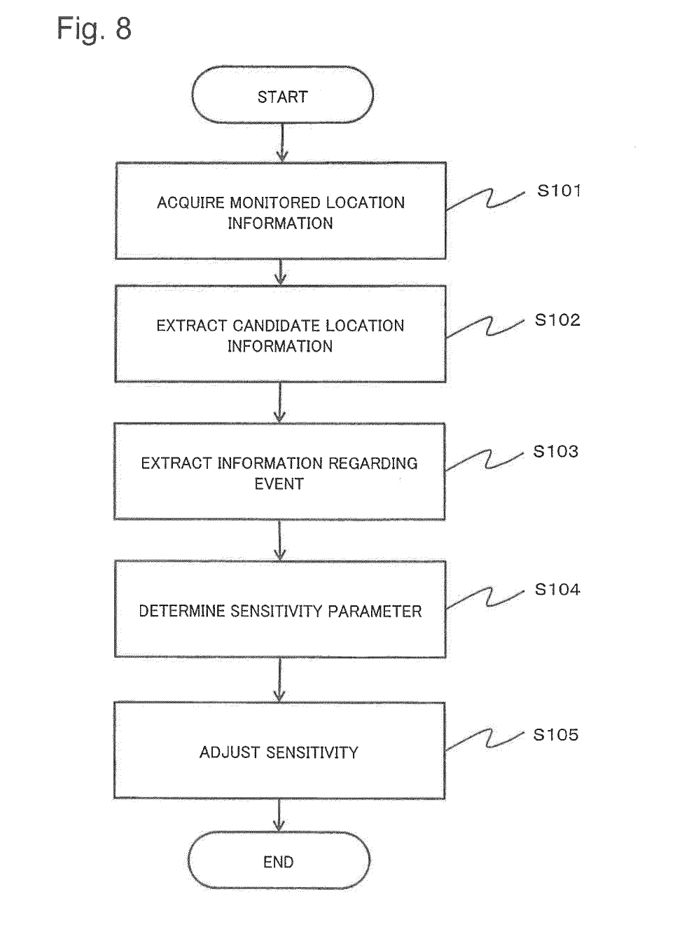

Next, an operation of the sensitivity adjustment device 400 according to the second exemplary embodiment will be described. FIG. 8 is a flow chart illustrating the operation of the sensitivity adjustment device 400.

The monitored location acquisition unit 410 acquires the monitored location information representing the monitored location that is the location monitored by the monitoring system 2000 (Step S101).

The candidate location extraction unit 420 extracts the candidate location information representing the candidate location that is close to the monitored location and is a location where an event influencing the degree of congestion of persons or vehicles may occur (Step S102).

The event extraction unit 430 extracts information regarding the event to occur in the candidate location from the database in which a text representing the event is stored, using the candidate location information as a key (Step S103).

The sensitivity determination unit 440 determines the sensitivity when the monitoring system 2000 detects the abnormal situation that occurs in the monitored location in response to the degree of congestion in the monitored location, which is expected based on the candidate location information and the information regarding the event extracted by the event extraction unit 430 (Step S104).

The sensitivity adjustment unit 460 updates the rule stored in the rule storage unit 120 included in the monitoring server 100, based on the sensitivity adjustment parameter determined by the sensitivity determination unit 440 (Step S105).

The operation illustrated by Step S105 may be not an operation executed by the sensitivity adjustment device 400 but an operation executed by the monitoring server 100.

Next, another variation of the method for the sensitivity determination unit 440 to determine the sensitivity adjustment parameter will be described.

### <Another Variation 1>

The “information regarding the event” extracted by the event extraction unit 430 may be, for example, information indicating the expected number of participants of the event to be held. For example, in the case where a similar event was held in the same location in the past, the event extraction unit 430 obtains the foregoing information by searching a text representing the number of participants of the event held in the past. Specifically, for example, in the case where the text representing the event directly includes a description of the number of participants of the past, the event extraction unit 430 obtains information representing the expected number of participants of the event. The case where the text representing the event directly includes a description of the number of participants of the past is, for example, the case where the text includes the description such as “the previous number of participants was 1000 persons”. In the above-described case, the expected number of participants is 1000 persons.

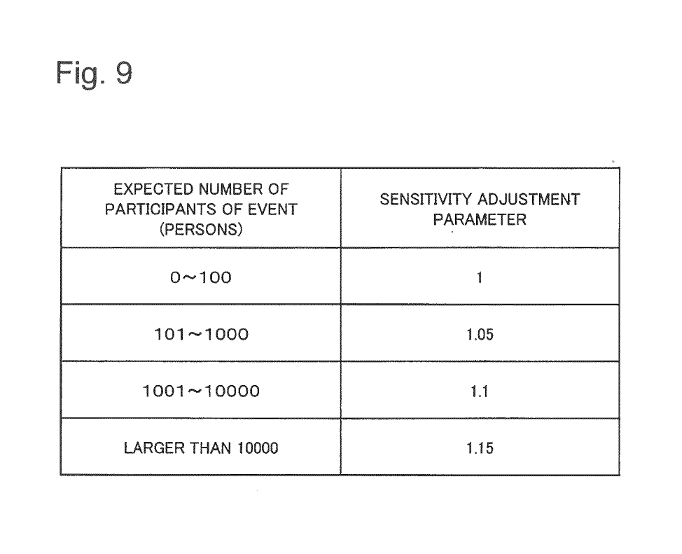

FIG. 9 is a diagram illustrating an example of the information stored by the sensitivity table 450. The sensitivity table 450 illustrated in FIG. 9 includes information in which the expected number of participants to participate the event is associated with the sensitivity adjustment parameter.

Based on the “information representing the expected number of participants to participate the event” extracted by the event extraction unit 430, the sensitivity determination unit 440 may determine the sensitivity adjustment parameter by referring to the sensitivity table 450.

The sensitivity determination unit 440 outputs the determined sensitivity adjustment parameter.

### <Another Variation 2>

The event extraction unit 430 may extract the type of the event to occur in the candidate location information by referring to an event type dictionary 470 not illustrated in the drawing.

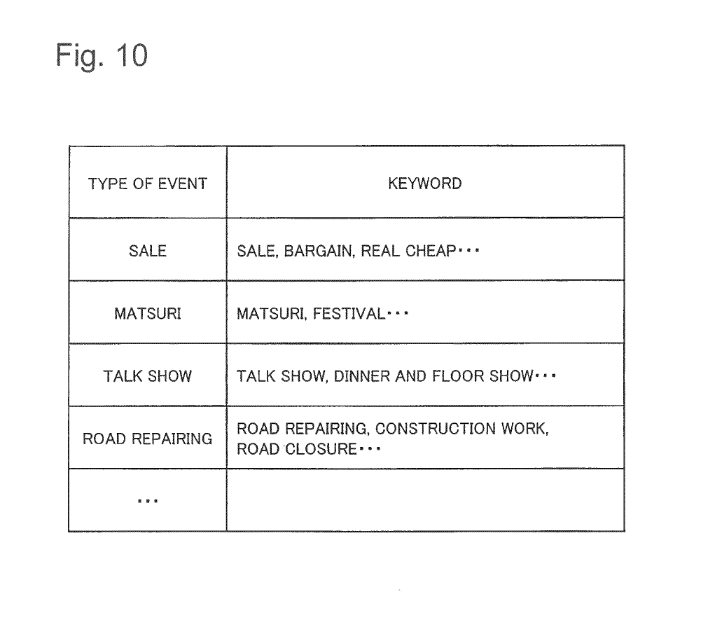

FIG. 10 is a diagram illustrating an example of information stored by the event type dictionary 470. As illustrated in FIG. 10, the event type dictionary 470 associates a word indicating the type of the event with an expression that is easy to co-occur with the word indicating the type of the event, and stores them.

For example, the event type dictionary 470 stores “sale”, “bargain”, and “real cheap” as the keyword that is easy to co-occur with the event “sale”. For example, a document including the event name is searched and a high-frequency expression that is easy to co-occur with the event name, which appears in the searched document, is recorded in an event type keyword storage unit as a keyword so that the event type dictionary 470 is created.

The event extraction unit 430 extracts appearance frequency of the keyword stored by the event type dictionary 470, from the text information describing the event searched using the candidate location information as a key. For example, the event extraction unit 430 determines the type of the event including the keyword whose appearance frequency is maximum, as the type of the event.

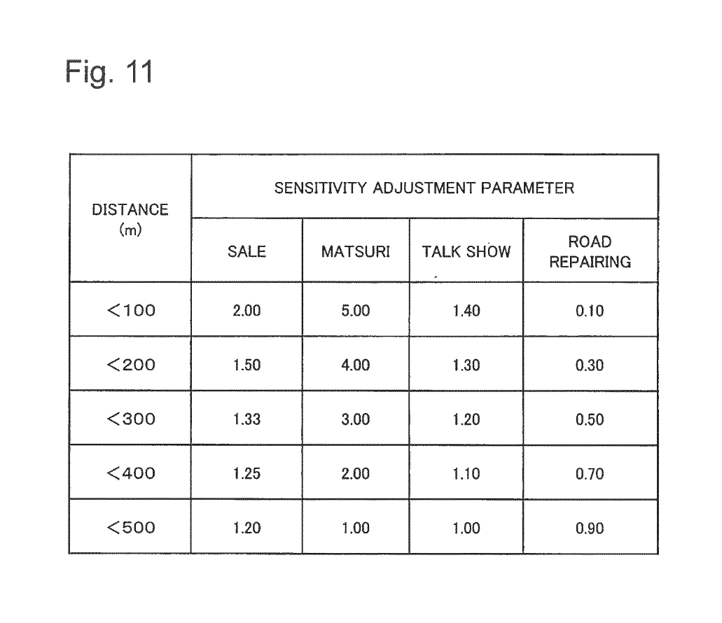

FIG. 11 is a diagram illustrating an example of the information stored by the sensitivity table 450. As illustrated in FIG. 11, the sensitivity table 450 stores information in which the sensitivity adjustment parameter, the distance from the monitored location to the candidate location, and the type of the event are associated with one another.

Based on the distance between the monitored location and the candidate location and the type of the event extracted by the event extraction unit 430, the sensitivity determination unit 440 determines the sensitivity adjustment parameter referring to the sensitivity table 450. The sensitivity determination unit 440 outputs the determined sensitivity adjustment parameter.

Effects achieved by the sensitivity adjustment device 400 according to the second exemplary embodiment will be described.

According to the sensitivity adjustment device 400, the sensitivity for detecting occurrence of the abnormal situation can be appropriately adjusted in response to the degree of congestion in the monitored location.

Because of low performance of the monitoring server 100 or because of low quality of information received from the sensor 200, it is sometimes difficult for the monitoring server 100 to determine the degree of congestion in the monitored location in real time. According to the sensitivity adjustment device 400, even in this case, the sensitivity to detect occurrence of the abnormal situation can be appropriately adjusted in response to the degree of congestion in the monitored location.

This is because, by using a text mining technique, the sensitivity adjustment device 400 perceives the event to occur close to the monitored location before monitoring is executed. In addition, this is because the sensitivity adjustment device 400 determines the sensitivity when the monitoring system 2000 detects the abnormal situation, based on the degree of congestion in the monitored location predicted by the event to occur close to the monitored location.

The monitoring operator 900 of the monitoring system 2000 cannot control the holding of the event that occurs close to the monitored location. According to the sensitivity adjustment device 400, with respect to the foregoing event for which the monitoring operator 900 of the monitoring system 2000 cannot control the presence or absence of the holding, the appropriate sensitivity in response to a change in the degree of congestion in the monitored location due to the event can be determined.

### Third Exemplary Embodiment

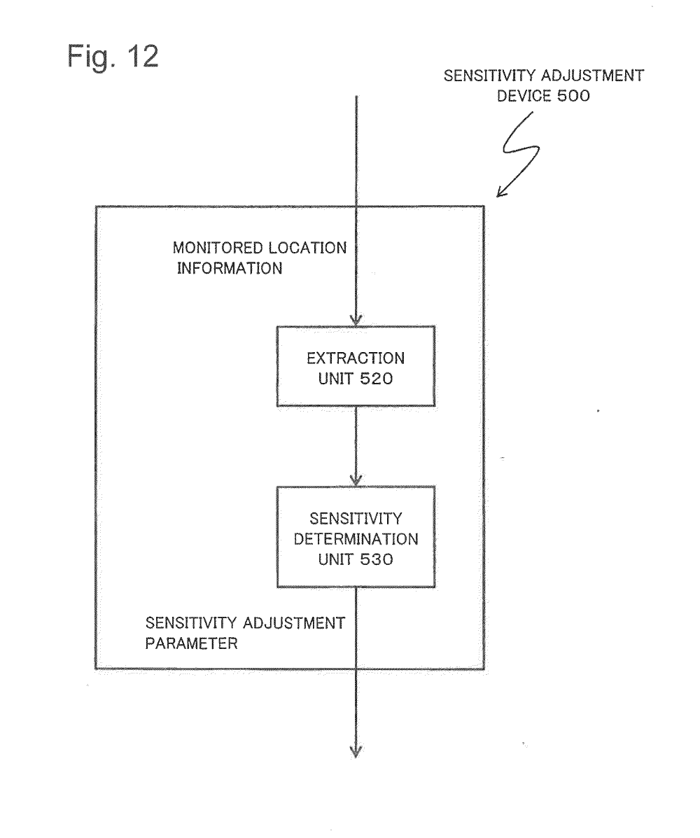

FIG. 12 is a block diagram illustrating a configuration of a sensitivity adjustment device 500 according to a third exemplary embodiment.

The sensitivity adjustment device 500 according to the third exemplary embodiment includes an extraction unit 520 and a sensitivity determination unit 530.

The extraction unit 520 extracts information regarding the event to occur in the monitored location from the database in which the text representing the event is stored, using the monitored location information representing the monitored location that is the location monitored by the monitoring system as a key.

The sensitivity determination unit 530 determines the sensitivity when the monitoring system detects the abnormal situation that occurs in the monitored location in response to the degree of congestion in the monitored location, which is expected based on the monitored location information and the information regarding the event extracted by the extraction unit 520.

Effects achieved by the sensitivity adjustment device 500 according to the third exemplary embodiment will be described.

According to the sensitivity adjustment device 500, the sensitivity to detect occurrence of the abnormal situation can be appropriately adjusted in response to the degree of congestion in the monitored location.

Because of low performance of the monitoring server 100 or because of low quality of information received from the sensor 200, it is sometimes difficult for the monitoring server 100 to determine the degree of congestion in the monitored location in real time. According to the sensitivity adjustment device 500, even in this case, the sensitivity to detect occurrence of the abnormal situation can be appropriately adjusted in response to the degree of congestion in the monitored location.

This is because, by using a text mining technique, the sensitivity adjustment device 500 perceives the event to occur in the monitored location before monitoring is executed. In addition, this is because the sensitivity adjustment device 500 determines the sensitivity when the monitoring system detects the abnormal situation, based on the degree of congestion in the monitored location predicted by the event to occur in the monitored location.

### Fourth Exemplary Embodiment

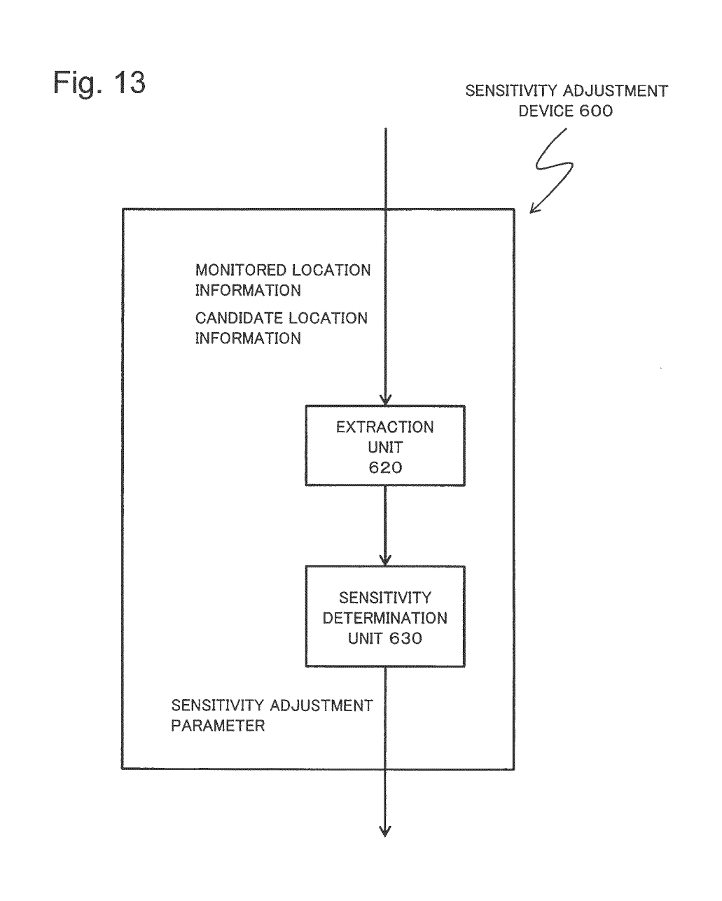

FIG. 13 is a block diagram illustrating a configuration of a sensitivity adjustment device 600 according to a fourth exemplary embodiment. As illustrated in FIG. 13, the sensitivity adjustment device 600 of the fourth exemplary embodiment includes an extraction unit 620 and a sensitivity determination unit 630.

The extraction unit 620 extracts information regarding the event to occur in the candidate location from the database in which the text representing the event is stored, using the candidate location information as a key. The candidate location information is information indicating the candidate location. The candidate location is a location close to the monitored location that is a location monitored by the monitoring system and is a location where the event influencing the degree of congestion of the monitored target may occur. The sensitivity determination unit 630 determines the sensitivity when the monitoring system detects the abnormal situation that occurs in the monitored location in response to the degree of congestion in the monitored location, which is expected based on the candidate location information and the information regarding the event extracted by the extraction unit 620.

Effects achieved by the sensitivity adjustment device 600 according to the fourth exemplary embodiment will be described.

According to the sensitivity adjustment device 600, the sensitivity to detect occurrence of the abnormal situation can be appropriately adjusted in response to the degree of congestion in the monitored location.

### Modified Examples of Respective Exemplary Embodiments

The threshold value of the distance determined by the candidate location extraction unit 420 may be set to be an arbitrary value by the monitoring operator 900 of the monitoring system.

The case where multiple monitoring rules are set in the rule storage unit 120 will be assumed. In this case, the monitoring operator 900 of the monitoring system sometimes wants to adjust only sensitivities of some monitoring rules among the multiple monitoring rules. In this case, the sensitivity adjustment unit 460 may outputs sensitivity adjustment parameters while specifying monitoring rules to which the sensitivity adjustment parameters should be calculated.

The holding period of the event extracted by the event extraction unit 430 may include information of not only a date when the event occurs but also time when the event occurs. When associating the determined sensitivity with the holding period of the event and outputting them, the sensitivity determination unit 440 does not necessarily output the holding period itself of the event extracted by event extraction unit 430. For example, by estimating time it takes persons to move to the monitored location from the candidate location in consideration of the distance from the monitored location to the candidate location, the sensitivity determination unit 440 may associate time that is shifted from the holding period of the event by the estimated time with the sensitivity adjustment parameter and output them.

In the sensitivity table 450, the sensitivity adjustment parameter in which the influence on the sensitivity of the monitoring rule is decreased as the distance from the monitored location to the candidate location is shortened may be set. In the sensitivity table 450, the sensitivity adjustment parameter in which the sensitivity of the monitoring rule is increased as the distance from the monitored location to the candidate location is shortened may be set.

The monitored location acquisition unit 410 may receive the monitored location information from an external device of the sensitivity adjustment device 400. The monitored location acquisition unit 410 may receive input of the monitored location information from the monitoring operator 900 of the monitoring system 2000. The monitored location acquisition unit 410 may read the monitored location information from a storage unit not illustrated in the drawing, which is included in the sensitivity adjustment device 400.

The extraction unit 520 may receive the monitored location information from an external device of the sensitivity adjustment device 500. The extraction unit 520 may receive input of the monitored location information from the monitoring operator 900. The extraction unit 520 may read the monitored location information from a storage unit not illustrated in the drawing, which is included in the sensitivity adjustment device 500.

The database in which the text representing the event is stored, which the extraction unit 520 accesses, may be included in the sensitivity adjustment device 500, or may be included in an external device connected to the sensitivity adjustment device 500 through a communication network.

The extraction unit 620 may receive the monitored location information or the candidate location information from an external device of the sensitivity adjustment device 600. The extraction unit 620 may receive input of the monitored location information or the candidate location information from the monitoring operator 900. The extraction unit 620 may read the monitored location information or the candidate location information from a storage unit not illustrated in the drawing, which is included in the sensitivity adjustment device 600.

The database in which the text representing the event is stored, which the extraction unit 620 accesses, may be included in the sensitivity adjustment device 600, or may be included in an external device connected to the sensitivity adjustment device 600 through a communication network.

The number of the variables included in the monitoring rule is not necessarily one. For example, the following Monitoring Rule will be considered.

For example, in order to monitor purse-snatching, the monitoring rule by which a monitoring camera is made to focus on a person who is easy to be a victim of purse-snatching will be assumed. The foregoing monitoring rule is, for example, the following Monitoring Rule.

Monitoring Rule: “if (a person caught by an image is a woman at a degree of reliability of A % or more) and (the person is sixty years of age and older at a degree of reliability of B % or more) then (make a monitoring camera focus on the person)”.

The sensitivity adjustment parameter may adjust all of multiple variables (A and B in the above-described example) included in the above-described Monitoring Rule, or may adjust a part of the multiple variables.

The method for the sensitivity adjustment parameter to adjust the sensitivity of the monitoring rule is not necessarily only the method in which the value of the variable included in the monitoring rule is adjusted. For example, the case where the conditional clause of the monitoring rule includes a condition in which multiple conditions are combined by “and” will be assumed. The sensitivity adjustment unit 460 may adjust the sensitivity of the monitoring rule by changing “and” included in the conditional clause of the monitoring rule to “or” in response to the sensitivity adjustment parameter. The sensitivity adjustment unit 460 may adjust the sensitivity of the monitoring rule by ignoring a part of the conditions combined by “and” in response to the sensitivity adjustment parameter.

For example, in the example of the above-described Monitoring Rule, the sensitivity may be adjusted as follows in response to the sensitivity adjustment parameter.

Monitoring Rule: “if (a person caught by an image is a woman at a degree of reliability of A % or more) or (the person is sixty years of age and older at a degree of reliability of B % or more) then (make a monitoring camera focus on the person)”.

For example, in the example of the above-described Monitoring Rule, the sensitivity may be adjusted as follows in response to the sensitivity adjustment parameter.

Monitoring Rule: “if (a person caught by an image is a woman at a degree of reliability of A % or more) then (make a monitoring camera focus on the person)”.

The above-described modified examples can be applied to other exemplary embodiments.

### Example of Hardware Configuration of Sensitivity Adjustment Device in Respective Exemplary Embodiments

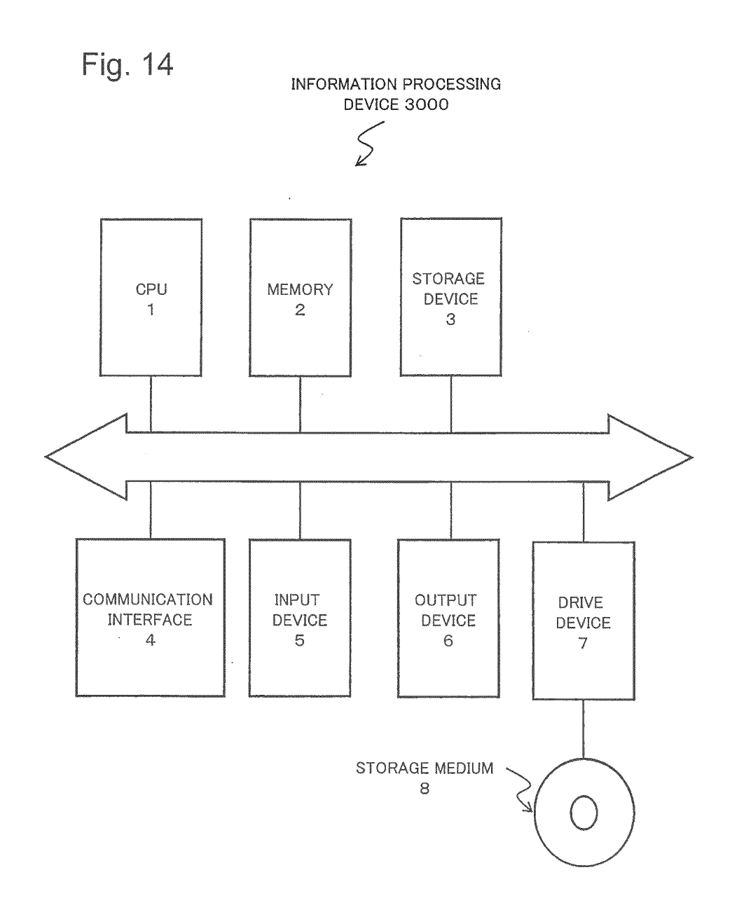

FIG. 14 is a diagram illustrating an example of a hardware configuration of an information processing device (computer), which can achieve the sensitivity adjustment devices in the respective exemplary embodiments. The hardware configuring an information processing device 3000 includes a CPU (Central Processing Unit) 1, a memory 2, a storage device 3, and a communication interface (I/F) 4. The information processing device 3000 may include an input device 5 and an output device 6. For example, the CPU 1 executes a computer program (software program, hereinafter just referred to as “program”) read by the memory 2 so that functions of the information processing device 3000 are achieved. In the execution, the CPU 1 arbitrarily controls the communication interface 4, the input device 5, and the output device 6.

The present invention described using the present exemplary embodiment and the respective exemplary embodiments described below as examples may also be configured by a non-volatile storage medium 8, such as a compact disc, storing such a program. The program stored in the storage medium 8 is read by a drive device 7, for example.

For example, an application program controls the communication interface 4 using functions which an OS (Operating System) provides so that the communication which the information processing device 3000 executes is achieved. The input device 5 is, for example, a keyboard, a mouse, or a touch panel. The output device 6 is, for example, a display. The information processing device 3000 may be configured by wired or wireless connection of two or more physically-separated devices.

The hardware configuration of the sensitivity adjustment device and functional blocks thereof is not limited to the above-described configuration.

Moreover, the above-described respective exemplary embodiments can be implemented by being arbitrarily combined. Furthermore, the present invention can be implemented in various forms without limiting to the above-described respective exemplary embodiments.

Dividing into blocks illustrated in the respective block diagrams is configurations illustrated for the purpose of description. When being mounted, the present invention described using the respective exemplary embodiments as examples is not limited to the configurations illustrated in the respective block diagrams.

Heretofore, the exemplary embodiments of the present invention have been described, but the above-described exemplary embodiments are those for the purpose of easy understanding of the present invention, not for limitedly interpreting the present invention. The present invention can be changed and modified without departing from the scope thereof, and equivalents thereof are included in the present invention.

This application is based upon and claims the benefit of priority from Japanese patent application No. 2013-132738, filed on Jun. 25, 2013, the disclosure of which is incorporated herein in its entirety by reference.

### INDUSTRIAL APPLICABILITY

The present invention can be used for a sensitivity adjustment device, a sensitivity adjustment method, and a program that adjust a sensitivity of a monitoring system, and for a monitoring system.

### REFERENCE SIGNS LIST

100 monitoring server
110 rule determination unit
120 rule storage unit
200 sensor
300, 600 sensitivity adjustment device
310 congestion degree determination unit
320, 530 sensitivity determination unit
400, 500 sensitivity adjustment device
410 monitored location acquisition unit
420 candidate location extraction unit
430 event extraction unit
440, 630 sensitivity determination unit
450 sensitivity table
460 sensitivity adjustment unit
470 event type dictionary
520, 620 extraction unit
900 monitoring operator
1000, 2000 monitoring system
3000 information processing device

What is claimed is:

1. A sensitivity adjustment device comprising:
extraction unit that extracts, based on candidate location information representing a candidate location where close to a monitored location monitored by a monitoring system and where an event influencing a degree of congestion of a monitored target may occur, information regarding the event to occur in the candidate location, from a database in which a text representing the event is stored; and
sensitivity determination unit that determines a sensitivity when the monitoring system detects an abnormal situation that occurs in the monitored location in response to the degree of congestion in the monitored location, which is expected based on the candidate location information and the information regarding the event extracted by the extraction unit.

2. The sensitivity adjustment device according to claim 1, which is used in the monitoring system including a sensor and a monitoring server, wherein
the sensor measures a condition in the monitored location,
the monitoring server monitors whether an abnormality occurs in the monitored location based on information representing a result of a measurement by the sensor and a monitoring rule set in advance while being associated with the monitored location,
the monitoring rule is a rule that includes information defining a specific condition and is used to monitor whether an abnormality occurs in the monitored location based on a determination of whether the result of the measurement by the sensor satisfies the specific condition,
the information defining the specific condition includes at least one variable, and
the sensitivity determination unit included in the sensitivity adjustment device determines a sensitivity adjustment parameter used in adjustment of a value of the variable included in the information defining the specific condition.

3. The sensitivity adjustment device according to claim 1, wherein
the sensitivity determination unit calculates a distance between the monitored location and the candidate location based on positional information of the monitored location and positional information of the candidate location, and determines the sensitivity adjustment parameter based on the calculated distance.

4. The sensitivity adjustment device according to claim 1, wherein
the extraction unit extracts a type of the event to occur in the candidate location, and
the sensitivity determination unit determines the sensitivity adjustment parameter based on the type of the event extracted by the extraction unit.

5. The sensitivity adjustment device according to claim 2, wherein
the monitoring rule is set while being associated with the monitored location and a specific period,
the extraction unit extracts the event to occur in the candidate location together with a period of the event to be held, and
the sensitivity determination unit determines the sensitivity adjustment parameter for adjusting the value of the variable included in the information defining the specific condition, based on the period of the event to be held and the information regarding the event extracted by the extraction unit, and calculates the determined sensitivity adjustment parameter together with information specifying the specific period.

6. A monitoring system comprising
the monitoring server and the sensitivity adjustment device according to claim 2.

7. A sensitivity adjustment method by a computer, comprising:
extracting, based on candidate location information representing a candidate location where close to a monitored location monitored by a monitoring system and where an event influencing a degree of congestion of a monitored target may occur, information regarding the event to occur in the candidate location, from a database in which a text representing the event is stored; and
determining a sensitivity when the monitoring system detects an abnormal situation that occurs in the monitored location in response to the degree of congestion in the monitored location, which is expected based on the candidate location information and the information regarding the extracted event.

8. A non-transitory computer-readable storage medium storing a program which makes a computer execute:
processing of extracting, based on candidate location information representing a candidate location where close to a monitored location monitored by a monitoring system and where an event influencing a degree of congestion of a monitored target may occur, information regarding the event to occur in the candidate location, from a database in which a text representing the event is stored; and
processing of determining a sensitivity when the monitoring system detects an abnormal situation that occurs in the monitored location in response to the degree of congestion in the monitored location, which is expected based on the candidate location information and the information regarding the extracted event.

9. A sensitivity adjustment device comprising:
extraction unit that extracts, based on monitored location information representing a monitored location monitored by a monitoring system, information regarding an event to occur in the monitored location from a database in which a text representing the event is stored; and
sensitivity determination unit that determines a sensitivity when the monitoring system detects an abnormal situation that occurs in the monitored location in response to a degree of congestion in the monitored location, which is expected base on the monitored location information and the information regarding an event extracted by the extraction unit.

10. A sensitivity adjustment device comprising:
congestion degree determination unit that receives, from a sensor that measures a condition in a monitored location monitored by a monitoring system, information representing the condition in the monitored location, and determining a degree of congestion of persons or vehicles in the monitored location based on the received information; and
sensitivity determination unit that determines a sensitivity when the monitoring system detects an abnormal situation that occurs in the monitored location in response to the degree of congestion in the monitored location determined by the congestion degree determination unit.
